(19) United States
(12) Patent Application Publication
(10) Pub. No.: US 2004/0253570 A1
(43) Pub. Date: Dec. 16, 2004

(54) Magic letter links

(76) Inventor: Brian P. Piller, Helena, MT (US)

Correspondence Address: Brian Piller, Suite 3, 533 North Rooney, Helena, MT, 59601, US

(21) Appl. No.: 10/680,680

(22) Filed: Aug. 2, 2004

Related U.S. Application Data
(60) Provisional application No. 60/416,416, filed on Oct. 7, 2002.

(51) Int. Cl. G09B 23/02; G09B 23/04

(52) U.S. Cl. 434/211

(57) ABSTRACT

An educational toy kit to teach the alphabetic and numeric systems, the kit comprising a plurality of pieces. Each of the pieces are shaped into one of five geometic shapes, and in various sizes, from which a letter or number may be joined to form a letter of the alphabet or a number. The shapes of the pieces consist of C-shapes, I-shapes and U-shapes. The pieces may be made of wood or plastic.

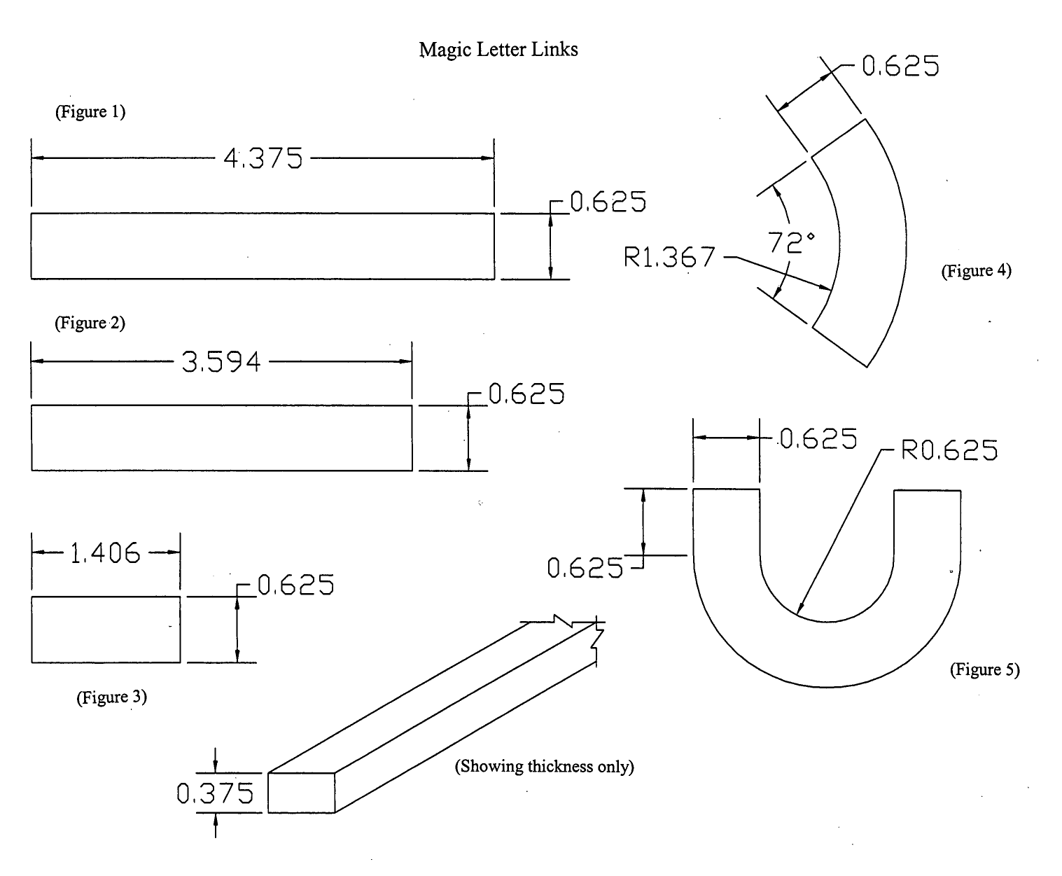

I am claiming benefit of filing date Oct. 7^{th}, 2002 (application No. 60/416,416) for non-provisional patent protection:

I have developed a product that will be used as an educational tool to help children understand and learn the alphabet and numeric systems (A through Z and 0 through 9). The result of this learning approach builds confidence and engages their natural skills to make letters, numbers and then sentences from the shapes called Magic Letter Links. This system of making letters with their own hands has additional special application for children that are learning-challenged or conceptualize differently.

This invention (Magic Letter Links) allows the construct of the entire alpha/numeric system using only five geometric shapes. There are 110 pieces in a set that can complete the alphabet and numeric system. Each shape represents part of the 110 pieces. For example, there are 29 U shaped pieces. Depending on the desired letter or number, it requires one or more of these shapes in varying combinations to make the appropriate formation. Magic Letter Links were designed to be conducive for developing a child's natural cognitive abilities. The letter link product uses all the essential components of learning; namely, the multi-sensory, tactile and manipulative skills all youngsters have in varying degrees.

The drawing attached explains the width, length and thickness of the straight shapes and the radius of the two curved pieces. They are numbered 1 through 5 on the drawing. We have developed them in plastic and wood. They will be orange or yellow in color. The pieces can be put together many different ways—wholly contingent on the abilities of the individual attempting the assembly. Moreover, the central claim is to help all children learn, but especially those with different learning styles.

I am claiming benefit of filing date Oct. 7^{th}, 2002 (application No. 60/416,416) for non-provisional patent protection:

I have developed a product that will be used as an educational tool to help children understand and learn the alphabet and numeric systems (A through Z and 0 through 9). The result of this learning approach builds confidence and engages their natural skills to make letters, numbers and then sentences from the shapes called Magic Letter Links. This system of making letters with their own hands has additional special application for children that are learning-challenged or conceptualize differently.

This invention (Magic Letter Links) allows the construct of the entire alpha/numeric system using only five geometric shapes. There are 110 pieces in a set that can complete the alphabet and numeric system. Each shape represents part of the 110 pieces. For example, there are 29 U shaped pieces. Depending on the desired letter or number, it requires one or more of these shapes in varying combinations to make the appropriate formation. Magic Letter Links were designed to be conducive for developing a child's natural cognitive abilities. The letter link product uses all the essential components of learning; namely, the multi-sensory, tactile and manipulative skills all youngsters have in varying degrees.

The drawing attached explains the width, length and thickness of the straight shapes and the radius of the two curved pieces. They are numbered 1 through 5 on the drawing. We have developed them in plastic and wood. They will be orange or yellow in color. The pieces can be put together many different ways—wholly contingent on the abilities of the individual attempting the assembly. Moreover, the central claim is to help all children learn, but especially those with different learning styles.

I claim:

1. An educational toy kit, comprising:
(a) a plurality of pieces,
(b) each of said pieces having one of five geometric shapes,
(c) said five geometric shapes selected from a group consisting of C-shapes, U-shapes and I-shapes, and
(d) whereby said pieces are configured to be joined to form alphanumeric characters.

2. The educational toy kit as claimed in claim 1, wherein the group of alphanumeric characters are selected from a group consisting of letters and numbers.

3. The educational toy kit as claimed in claim 1, wherein each of the pieces are in a plurality of sizes.

4. The educational toy kit as claimed in claim 1, wherein said pieces are made of wood material or plastic material.
